(19) United States
(12) Patent Application Publication
(10) Pub. No.: US 2019/0188776 A1
(43) Pub. Date: Jun. 20, 2019

(54) DATA STRUCTURE SYSTEMS AND METHODS THAT RECEIVE AND GENERICIZE RECIPES

(71) Applicant: Walmart Apollo, LLC, Bentonville, AR (US)

(72) Inventors: Adam G. Hammond, Rogers, AR (US); Chad Rivoli, Bentonville, AR (US)

(21) Appl. No.: 16/221,072

(22) Filed: Dec. 14, 2018

Related U.S. Application Data
(60) Provisional application No. 62/607,096, filed on Dec. 18, 2017.

(51) Int. Cl. G06Q 30/06; G06Q 20/20; G06F 17/27

(52) U.S. Cl. CPC G06Q 30/0633; G06Q 30/0631; G06F 17/2705; G06Q 20/203; G06Q 30/0639

(57) ABSTRACT

In some embodiments, systems and methods incorporate customer-supplied recipes, comprising: a control circuit; a recipe database; a network interface coupled with an external network; wherein the control circuit is configured, to: receive recipe information of a recipe; define a genericized recipe component (RC) record with the recipe; identify, for each ingredient, a unique product identifier; obtain a set of rules that genericize a recipe as a function of linking defined within the recipe data structure; apply the first set of rules to: parse, for each identified unique product identifier, the recipe data structure and identify, based on linking corresponding to an RCI record, a primary RC record; and create a genericized recipe from the generic classes of products corresponding to the identified primary RC records, and exclusively associating the genericized recipe with the genericized RC record.

### CROSS-REFERENCE TO RELATED APPLICATION

This application claims the benefit of U.S. Provisional Application No. 62/607,096, filed Dec. 18, 2017, which is incorporated herein by reference in its entirety.

### TECHNICAL FIELD

This invention relates generally to a method and system providing an improved compatibility data structured database architecture used in storing, retrieving, and distributing various kinds of data.

### BACKGROUND

Storing and retrieving data is critical to servers, computers, networked systems and the like. Many such systems, however, require excess processing and distribution of data. Further, many such systems are cumbersome in providing access to the storage and/or the data stored in that storage.

### BRIEF DESCRIPTION OF THE DRAWINGS

Disclosed herein are embodiments of systems, apparatuses and methods providing an improved compatibility data structured database architecture and method of utilization of that data structure database. This description includes drawings, wherein:

FIG. 1 illustrates a simplified block diagram of an exemplary data structure management and fulfillment system, in accordance with some embodiments;

FIG. 2 illustrates a simplified representation of linking of a portion of an exemplary recipe data structure relative to a single genericized RC record, in accordance with some embodiments;

FIG. 3 illustrates a simplified flow diagram of an exemplary process of storing and retrieving data in a computer memory providing retail-specific instantiations of items of recipes, in accordance with some embodiments;

FIG. 4 illustrates a simplified flow diagram of an exemplary process of maintaining and providing access to customer-supplied recipes, in accordance with some embodiments; and

FIG. 5 illustrates an exemplary system for use in implementing methods, techniques, devices, apparatuses, systems, servers, sources and providing customized instantiations of projects, recipes and the like, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods provide improved data structure databases that enable precision identification and instantiation of specific products or items for purchase through a hierarchical categorization and instantiation allocation of data. This data structure database can be utilized, for example, in correlating particular unique product identifiers to generalized ingredients of recipes, projects, tasks and the like that are maintained by a retailer and made accessible by customers desiring to purchase products to implement the recipes, projects, tasks, and the like. Some embodiments provide systems that utilize these data structure databases to readily store and retrieve data in a computer memory providing retail-specific instantiations of items of recipes, projects, instructions, or the like. The below embodiments are described with reference to recipes, however, the systems and methods can similarly be applied to instructions for projects, tasks and the like (e.g., woodworking projects, home repair projects, home improvement projects, auto repair projects, and the like), where products are likely to be purchases to perform and/or complete the projects, tasks, etc.

Still further, generally speaking, the system includes at least one control circuit that communicatively couples with one or more databases, such as a recipe database that stores a hierarchical recipe data structure, an inventory database specific to a particular retailer having thousands of products available for purchase by customers, a customer database, and/or other such databases. Typically, the control circuit couples with one or more point-of-sale systems allowing the control circuit to at least initiate a purchase of one or more products identified based on a recipe a customer intends to implement. The control circuit, for at least one particular retailer, maintains the recipe data structure to continuously be current and updated by, in part, adding and removing hierarchical relationships within the recipe data structure. The recipe data structure is maintained to comprise: a plurality of genericized recipe component (RC) records, a plurality of tiers of RC records, and a plurality of recipe component instantiation (RCI) records.

In some embodiments, each of the genericized RC records corresponds to a single instance of a recipe and comprises a genericized RC record identifier, and at least one cell comprising a link to at least one of: at least one of the subordinate RC records and at least one of the RCI records. Further, the recipe data structure is implemented with a plurality of tiers of RC records, with each RC record linking to one or more RCI records, and/or one or more predecessor or subsequent RC records. The linking establishes a hierarchical association between each genericized RC record to multiple specific items that can be utilized in actually implementing the corresponding recipe of that genericized RC record. Accordingly, each RC record is dependent upon and associated with at least one of the plurality of genericized RC records and at least some of the RC records are dependent upon and associated with one or more predecessor RCs from one or more higher tiers. Further, each of the RC records comprises an RC record identifier and at least one cell comprising a link to one or more of: at least one further subordinate RC record and at least one of the plurality of RCI records.

The plurality of RCI records typically comprise an RCI identifier and a particular unique product identifier (e.g., stock keeping unit (SKU) value, bar code number, inventory number, radio frequency identifier (RFID) code or number, and/or other such unique product identifiers) corresponding to a particular product to be purchased from the particular retailer. Utilizing the maintained recipe data structure, the control circuit, in implementing code accessible to and/or within the control circuit, is configured to obtain a recipe identifier identified in a request from a customer. A first genericized RC record is identified that corresponds to the requested recipe identifier. Based on this identified genericized RC record, the control circuit parses through the tiers of RC records and corresponding RCI records for each link extending from genericized RC record to each RC record and each RCI record. From each identified RCI record linked to the genericized RC record the control circuit identifies each unique product identifier instantiated for the corresponding RCI records for specific products that can be used in implementing the identified recipe requested by the customer. Some embodiments apply one or more exclusion rules to exclude each unique product identifier where an on-hand inventory count for the corresponding product associated with the unique product identifier at the retailer is less than a minimum on-hand threshold. The control circuit uses the non-excluded product identifiers to generate a virtual shopping cart comprising a set of unique product identifiers configured to be applied by a point-of-sale system in purchasing for the customer products specific to each of the set of unique product identifiers, and cause the point-of-sale system to purchase the products corresponding to the set of unique product identifiers.

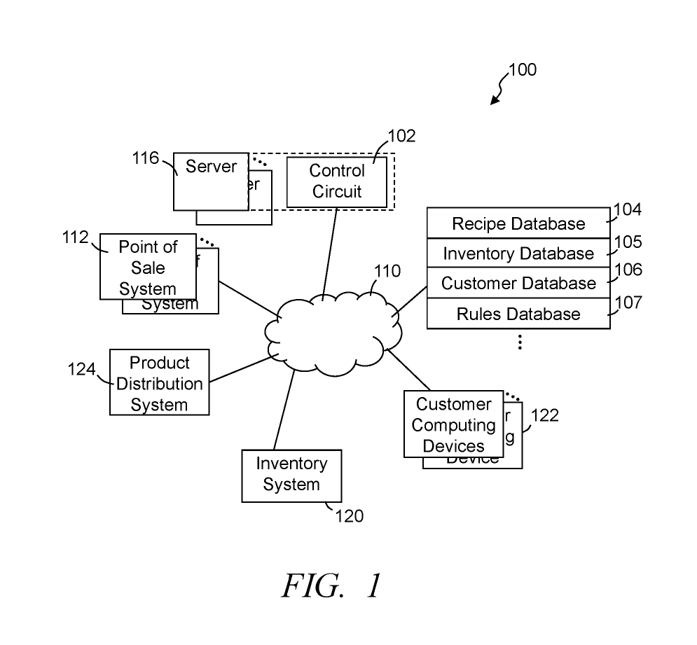

FIG. 1 illustrates a simplified block diagram of an exemplary data structure management and fulfillment system 100 that stores and retrieves data in a computer memory providing retail-specific instantiations of products of recipes, in accordance with some embodiments. The system includes at least one control circuit 102 and multiple databases 104 107, including at least a recipe database 104 and inventory database 105. The system typically further includes one or more point-of-sale (POS) systems 112 that are configured to complete a sales transaction of products for customers. The control circuit 102 is communicatively coupled with the databases 104-107 and the POS systems 112 through one or more wired and/or wireless communication and/or computer networks 110. In some embodiments, the control circuit is implemented in and/or is communicatively coupled with one or more network servers 116, which may be widely geographically distributed over the computer network (e.g., Internet) to allow customers to access the system 100 through their customer computing devices 122 (e.g., computers, laptops, smartphones, tablets, smart watches, other wearable devices, or other such customer computer devices). Accordingly, in some implementations, the servers provide a network interface communicatively coupling the control circuit with one or more external distributed communication networks 110. The system 100, in some implementations, further includes or is in communication with one or more product distribution systems 124 that coordinate and implement product distribution, such as through direct product delivery to customer identified locations, retail store pick-ups, and/or other such distribution. In some embodiments, the control circuit notifies the product distribution system 124 regarding the purchase and the product distribution system 124 schedules and coordinates the delivery of the product to the customer (e.g., through delivery vehicles, store pick-up, etc.).

The inventory database 105 maintains inventory information that is specific to at least one particular retailer that has thousands of products available for purchase by customers. At least in part, the inventory database maintains on-hand inventory data of the thousands of products, including quantities believed available. In some instances, the inventory database may further maintain information about products scheduled to be delivered, sales rates, predicted sales, sale floor quantities, back storage quantities, other such information, and often a combination of two or more of such information. The control circuit 102 or a separate inventory control circuit may maintain this inventory data. Information about shipments received and sales through the point of sale systems 112 are utilized to update and maintain the inventory data. Further, some embodiments take into consideration known and/or estimated losses (e.g., through theft, expired, damage, etc.) in updating the inventory information in the inventory database 105.

As described above, the control circuit 102 maintains the recipe data structure stored in the recipe database 104, which may be specific to a particular retailer (e.g., a particular store, a particular distribution center, a collection of stores, a collection of distribution centers, etc.). By maintaining the recipe data structure specific to a retailer, the availability of products for that retailer can be utilized in providing product information to the requesting customers based on the retailer from which the customer intends to purchase products. The control circuit 102 is configured, for the particular retailer, to maintain the recipe data structure based on input received over time that associates RCI records with preceding RC records and one or more corresponding genericized RC records. In some embodiments, the recipe data structure includes a plurality of genericized recipe component (RC) records that each corresponds to a single recipe. The recipe may have been received from a customer, entered by a retailer worker, obtained from a third party service, or received from some other source. For example, a customer through their customer computing device 122 may submit a recipe that identifies ingredients, and in some instances may specify specific products (e.g., specific type and size of flour, a specific size of semi-sweet chocolate chips from a specific company, etc.). The control circuit genericizes that recipe to enable the association of the genericized recipe to multiple different potential products that can be used to complete the recipe, which often includes linking different specific products for a single ingredient of the recipe. The genericization of the recipe greatly enhances the value and versatility of the recipe data structure beyond what has previously been available. Typically, other recipe systems maintain records of specific recipes with specific ingredients. These other recipe systems, however, generally do not associate specific ingredients with a particular product to satisfy that ingredient. Further, these other recipe systems do not establish linkings between a genericized ingredient to multiple different specific products that can satisfy that ingredient, which can then be evaluated relative to a particular customer in selecting or recommending specific products consistent with that customer.

In some embodiments, the recipe data structure comprises a plurality of genericized RC records, a plurality of tiers of RC records and RCI records, with linking from the genericized RC records through one or more tiers of RC records to corresponding RCI records. Further, each RC record is dependent upon and associated with at least one of the plurality of genericized RC records and at least some of the RC records are dependent upon and associated with one or more predecessor RC records from one or more higher tiers establishing a linking ladder to one or more genericized RC records.

Each of the genericized RC records corresponds to a different genericized recipe and comprises at least an identifier and at least one cell comprising a link to at least one subordinate RC record, which is typically a primary or class RC record. In some implementations, the genericized RC records further includes one or more recipe cells storing the steps to perform and quantities of ingredients to use in implementing the corresponding recipe, while in other instances, the genericized RC record includes a link to a separate database or memory that stores the recipe with the steps and quantities. Further, each genericized RC record typically links to multiple primary RC records, that each in turn link to multiple subordinate RC records in low tiers of tiers of RC records, and through these linking RC records down the tiers to multiple RCI records. Similarly, in some embodiments, each of the RC records comprises an RC record identifier and at least one cell comprising a link to at least one further subordinate RC record in a lower tier and/or at least one of the plurality of RCI records. Accordingly, each RC record of the plurality of tiers of RC records is dependent upon and associated with at least one of the plurality of genericized RC records and at least some of the RC records are dependent upon and associated with one or more predecessor RCs from one or more higher tiers. In some instances, the links may be defined based on the unique record identifiers of the RC records or RCI records. In other instances, the link may be a memory location, or the like. In some embodiments, each of the plurality of RCI records comprises an RCI identifier and a particular unique product identifier (e.g., stock keeping unit (SKU), RFID number or code, bar code number, and/or other such product identifier) corresponding to a particular product to be purchased from the particular retailer. Typically, the unique product identifier can be used to implement a purchase of that specific product (e.g., the unique product identifier can be supplied to and used by a point of sale system to complete a purchase of the corresponding product). In some implementations, one or more of the RCI records may include one or more cells that comprise one or more preceding links each defining a link to at least one preceding RC record, primary RC record and/or genericized RC record.

In some embodiments, the control circuit 102 in maintaining the recipe data structure is configured to receive, from a remote customer or other source, recipe information of a particular recipe. Typically, the recipe information comprises identifiers of each ingredient to be utilized in completing the recipe and a corresponding quantity of each ingredient. The identifier may be a type of product (e.g., sugar, cinnamon, cumin, sirloin steak, flour, apples, etc.), may identify a particular type of product (e.g., C&H® Golden Brown Sugar, Gold Medal™ All Purpose floor, etc.), or the like. Further, the specified quantity of the ingredients is typically limited to the amount needed to make the intended servings for the specific recipe (e.g., 3 cups, ⅓ cup, ½ teaspoon, 40 oz., 120 g., 100 ml., etc.). Based on the received specific recipe, the control circuit further defines, within the recipe data structure, a corresponding genericized RC (recipe component) record exclusively associated with the specific recipe. The control circuit 102 applies one or more sets of product identifier rules to identify, for each particular ingredient, a unique product identifier (e.g., stock keeping unit (SKU), RFID number, bar code number, and/or other such product identifier) corresponding to a particular product that can be used to satisfy the ingredient and the specified quantity of that ingredient. As described below, the product identifier rules in part utilize linkings defined within the recipe data structure, and/or may consider search terms, information relating products, and the like. Such rules may further exclude one or more products from consideration.

The control circuit, in some embodiments, further obtains one or more sets of genericizing rules that when applied genericize a recipe as a function of linking defined within the recipe data structure. Such genericizing is contradictory and inconsistent with other recipe systems that typically only store a type of product identified, or may identify a specific product. However, prior recipe systems do not genericize recipes to in part broaden the available specific products that can be used to satisfy the recipe, and do not use that genericized information to subsequently customize recipes. As described above, and further below, some embodiments associate products within the recipe data structure with a particular RCI record. Each RCI record includes an RCI identifier and at least one unique product identifier (e.g., a SKU, RFID number, etc.) that specifically identifies a product and typically can be used to purchase that specific product. The control circuit applies the one or more sets of genericizing rules to parse, for each identified unique product identifier, the recipe data structure based on the unique product identifier to identify, based on linking defined within the recipe data structure to an RCI record corresponding to the identified unique product identifier, a primary RC record corresponding to a generic class of products that comprises the particular product corresponding to the identified unique product identifier. A genericized recipe is created from the plurality of identified generic classes of products corresponding to the multiple identified primary RC records each linked to one of the RCI records each corresponding to an ingredient of the received recipe. The control circuit further exclusively associates the genericized recipe with the genericized RC record within the recipe data structure. Accordingly, the genericized RC record is linked, through the multiple tiers of RC records and RCI records, to multiple different RCI records exclusively associated with specific products that can be purchased for use in completing the recipe, and typically linked to multiple different RCI records for many if not all of the different ingredients.

In some implementations, the control circuit defines of a genericized RC record when a genericized RC record in which the specified recipe does not already exist within the recipe data base. The control circuit 102 can apply one or more sets of rules to confirm that a corresponding genericized recipe is not already defined in the recipe database. The recipe data structure can be parsed and the control circuit determines whether one or more existing genericized RC records, each corresponding to a separate different genericized recipe, are linked to each of the primary RC records of a combination set of primary RC records corresponding to the identified unique product identifiers of the received recipe. The control circuit can direct the creation of the genericized recipe when one or more of the existing genericized RC records do not link to the primary RC records of the combination set of primary RC records.

The control circuit in identifying the generic ingredient information, in some embodiments, accesses the recipe data structure, and within the recipe data structure for each identified unique identifier associated with an RCI record accesses the RCI record for the particular unique product identifier. Based on the RCI record, the control circuit can identify a predecessor RC record (e.g., a first RC record) linked to the particular RCI record, and parse the recipe data structure following a linking path from the predecessor RC record to a higher tier preceding predecessor RC record (e.g., a second RC record) linked to the predecessor RC record and within a link path to the primary RC record. For example, a recipe may call for almond extract. The control circuit may identify specific RCI records correlating to almond extract (e.g., a 2 oz. jar, and a 4 oz. jar). Additionally or alternatively, the control circuit may identify an RC record corresponding to the ingredient that is higher in the tier structure from the specific RCI records that may be used to satisfy that ingredient. As described above, the RC records include at least one cell comprising at least one link to a subordinate RC record and/or at least one RCI record. Accordingly, in some implementations, the higher tier predecessor second RC record comprises at least one cell that may comprise a link to at least the subordinate first RC record, and in some instances to multiple subordinate RC records including the subordinate first RC record. Additionally or alternatively, in some embodiments, the first RC record comprises a link to the higher tier second RC record defining two directional linking to higher and lower tiers or RC records and/or RCI records.

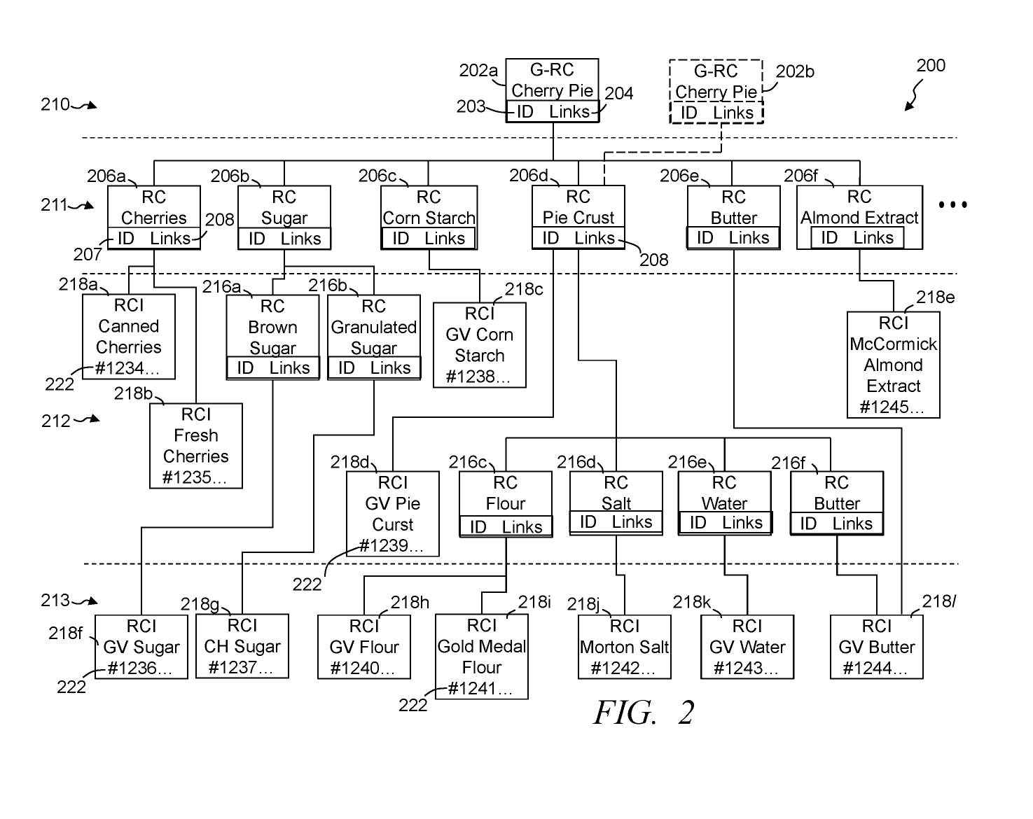

FIG. 2 illustrates a simplified representation of linking of a portion of an exemplary recipe data structure 200 relative to a single genericized RC record (G-RC) 202a, in accordance with some embodiments. In this simplified example, the genericized RC record 202a is associated with a specific cherry pie recipe, and includes the unique RC record ID 203, and one or more links 204, which in this example are represented by the lines extending from the presentation of the genericized RC record 202a. The cherry pie recipe genericized RC record 202a links to multiple primary RC records 206a-f that each correspond to one of the classes of the different ingredients for the particular cherry pie recipe. In this example, the primary RC records correspond to a cherries RC record 206a, a sugar RC record 206b, a corn starch RC record 206c, a pie crust RC record 206d, a butter RC record 206e, an almond extract RC record 206f, and could potentially link to other RC records. Each of the primary RC records 206a-f includes an RC record ID 207, and one or more links 208 to one or more RC records and/or RCI records in one or more lower tiers 212-213 of the recipe data structure. Again, the recipe data structure 200, in some implementations, establishes multiple tiers 210-213 providing the hierarchical categorization and instantiation allocation of data.

Typically, each of the primary RC records 206a-f further link to at least one of one or more subordinate RC records 216a-f and/or one or more RCI records 218a-l. For example, a primary RC record 206d may correspond to a “pie crust” record. The linking 208 of this pie crust RC record may link to multiple additional subordinate RC records 216c-f corresponding to multiple ingredients that can be used to make a pie crust (e.g., a flour RC record 216c, a salt RC record 216d, a water RC record 216e, a butter RC record 216f, and/or linkings to other such RC records). Further, in some instances, the pie crust RC record 206d may be linked to one or more genericized RC records 202b for a genericized pie crust recipe. Still further, the pie crust RC record 206d may additionally or alternatively be linked to one or more RCI records 218d each corresponding to specific product (e.g., Great Value Frozen Pie Crust). Again, the RCI record includes at least a unique product identifier 222, and in some instances may include or be associated with additional information, such as an RCI record ID.

Still referring to FIG. 2, as described above, each RC record 206, 216 links to at least one of: one or more other RC records in one or more tiers, and/or one or more RCI records. For example, the flour RC record 216c may link to one or more RCI records 218i-j (e.g., Great Value All Purpose flour, and Gold Medal™ All Purpose flour), and/or may link to one or more other RC records, which are not illustrated in FIG. 2, (e.g., All Purpose Flour RC record, Whole Wheat Flour RC record, Unbleached Flour RC record, Self-Rising Flour RC record, Organic Flour RC record, etc.). Each of these other RC records would link to one or more further RC records and/or one or more RCI records. Accordingly, the recipe data structure provides a hierarchical data structure, which allows for the genericization of recipes that are linked through the tiers to specific instantiations of ingredients. Further, the instantiation from general to specific typically provides for a plurality of different products, which may be different types of products and/or the same type of product with different quantities and/or sizes. The system 100 is configured to capitalize on this wide association of different products that can be used as a single ingredient in a recipe to provide numerous different instantiations of a single genericized recipe through various different combinations of the different instantiations of different ingredients.

In some embodiments, the control circuit in establishing a genericized RC record corresponding to a received recipe may receive a unique product identifier of a specific product that can be used to fulfill at least one of the ingredients. For example, as a customer enters the recipe the customer may be provided with a listing of potential products corresponding to the ingredient and from which the customer may select one of the listed products, a graphical user interface may display a set of graphical representations of one or more products correlated to the specified ingredient and allow the customer to select one or more of the displayed products, the customer may be able to initiate a search or shopping application that allows the customer to shop for a product to satisfy one or more ingredients and the application returns at least the unique customer identifier, and/or other such methods. In some applications, identification of potential products may be obtained through a word search of a database and/or inventory information, obtaining a listing based on previous recipe entries, and/or other such methods. The control circuit 102 in identifying for each particular ingredient the unique product identifier corresponding to the particular product to satisfy the ingredient can, in some implementations, receive a selection by the customer of the particular product and identifying the unique product identifier corresponding to the selected particular product, identify the corresponding RCI record associated with the identified unique product identifier, and link the RCI record with the genericized RC record and the received recipe.

Accordingly, in some implementations, the system 100 allows recipes to be added to the recipe database. The ingredients of the recipe and/or other factors of the recipe (e.g., descriptions, title, source, etc.) can be used to determine whether the recipe has already been incorporated into the recipe database. Still further, the system enables one or more specific products to be identified by a person adding the recipe that satisfy the one or more of the ingredients of the added recipe, and/or one or more specific products may be identified based on search terms and other methods. Corresponding RCI records 218 can be identified and the linking up through the tiers of the hierarchical data structure used by the system to genericize the recipe, which in turn allows subsequent linkings to be established. Additionally, based on the genericization the linking back down the hierarchical data structures provides a wide variety of different potential instantiations of particular products that can be purchased for multiple if not all of the ingredients.

As described above, the system 100 is further configured to utilize the recipe data structure to additionally or alternatively provide recipes to requesting customer while customizing a corresponding listing of products to be purchased with instantiations of specific products to implement the requested recipe. In some embodiments, the control circuit 102 utilizes the recipe data structure in cooperation with customer information in a customer database 106 to process the links branching from the genericized RC record corresponding to a selected recipe to identify linked RCI records and identify specific products for the specific customer to purchase that are to be used in implementing the recipe. The control circuit obtains a recipe identifier identified in a request from a customer. In some embodiments, the control circuit 102 and/or one or more of the servers 116 may distribute code, information, graphical user interfaces, and/or graphics to customers' computing devices 122 that cause a graphical user interface to be displayed, and/or provide customers with access to a graphical user interface displayed on their computing devices. For example, a customer may activate a software application (APP) on their customer computing device that accesses one or more servers 116 over the distributed computer and/or communication network 110 (e.g., the Internet) that supplies information to the APP to be used in rendering on the computing device content through the graphical user interface of the APP. The graphical user interface may display virtual options, menus, drop down menus, information and the like for accessing one or more recipes. For example, categories of types of recipes and/or cuisine may be displayed, a search field may be provided to allow customers to enter search terms and/or narrative to be used by the APP and/or server to search for relevant recipes, categories and/or other such methods of organization of recipes (e.g., based on: one or more ingredients, geographic origin, ethnicity, culture, dietary considerations, allergy considerations, other such organizational considerations, or often a combination of two or more of such organizational considerations, which in some instances may be selected by the customer), graphical representations and/or images of prepared foods corresponding to a recipe may be displayed, names and/or descriptions of recipes may be displayed, and other such options to allow customers to search, view, scroll through, and select a recipe. The selection of the recipe can provide a recipe identifier to the control circuit 102. Some embodiments provide a customer with a listing of recipes and the customer can select a recipe from the listing.

The control circuit 102 can utilize the recipe identifier to identify a genericized RC record (e.g., genericized RC record 202a) corresponding to the recipe identifier. In some embodiments, the recipe identifier corresponds to and/or is the unique RC record ID 203 for a particular genericized RC record. For some identifiers, the recipe data structure includes a linking between recipe identifiers that can be received from the customer to one or more genericized RC records. Utilizing the links defined within the recipe data structure corresponding to that specific genericized RC record, the control circuit parses through the tiers of RC records and corresponding RCI records for each link branching through the tiers from the genericized RC record to each subordinate RC record and each RCI record to identify each unique product identifier 222 instantiated for the corresponding RCI records that can be used in implementing the identified recipe. For example, referring to FIG. 2, the control circuit may receive the genericized RC record ID 203 for the genericized cherry pie recipe, and through the linking 204, 208 defined relative to the genericized RC record 202a and subordinate RC records 206, 216 the control circuit can identify each of the potential RCI records 218 linked to the specific cherry pie genericized RC record 202a.

In some embodiments, the control circuit 102 applies an exclusion rule based on inventory quantities (e.g., defined in the inventory database 105), and excludes each unique product identifier 222 where an on-hand inventory count for the unique product identifier at the retailer of interest is less than a minimum on-hand threshold. The threshold may be defined as whether there at least one of the products that is available for purchase, whether there is sufficient quantity to supply the customer's needs to complete the recipe, be based on sales rates and/or predicted sales of that identified specific product, based on predicted inventory error relative to the particular product, take into consideration a margin of error, and/or other such factors. For example, the system may identify a number and/or quantity of a particular product that the customer would purchase, and determine whether there is at least that quantity plus a margin of error (e.g., based on a predicted margin of error, a margin of error learned over time, and/or some other factor). Again, the margin of error may be based on a sales rate of the particular product, error rates of expected inventory quantities, and/or other such factors. Further, the error rate may be adjusted based on availability of alternative products. As such, in some implementations, the control circuit obtains the particular unique product identifier 222 from the RCI records 218, which typically can be used to implement purchases, for the products recommended that the customer purchase to implement the recipe. In some embodiments, the control circuit generates a virtual shopping cart comprising a set of the unique product identifiers configured to be applied by a point-of-sale system 112 in completing a purchase. Further, in some instances, the control circuit causes the products specific to each of the set of unique product identifiers in the virtual shopping cart to be purchased for the customer causing the point-of-sale system to purchase the products corresponding to the set of unique product identifiers. The control circuit typically accesses a customer database 106 to obtain relevant customer information, such as a method of completing the purchase (e.g., credit card number, account number, bank card number, etc.). In some instances, the control circuit further accesses the customer information within the customer database to confirm that the customer has authorized the system to implement the purchase on the customer's behalf. Further, the control circuit may communicate with the customer requesting confirmation of the purchase. For example, the control circuit may communicate a total cost to complete the purchase of the products in the virtual shopping cart to the customer through a user interface presented on the customer's computing device with an option to confirm the purchases and/or make edits to the purchases (e.g., removing one or more products, changing one or more products, adding one or more products, etc.).

The customer information maintained in the customer database 106 may further be used in determining what products to purchase and/or quantities of one or more product to purchase. In some embodiments, the control circuit 102 applies a set of one or more constraint rules specific to the customer requesting the recipe information and identifies, specific to the requesting customer, a set of RCI records 218 and a corresponding unique product identifier 222 of each RCI record of the set of RCI records to enable the customer to complete the recipe in accordance with constraints corresponding to the customer. These constraints can be applied to compile the set of the identified corresponding unique product identifiers 222 in populating the virtual shopping cart. These constraints may be pre-specified by the customer (e.g., limits on quantities and/or costs specified by the customer, limits on types of products to purchase, restrictions on sources of products, specified dietary and/or allergy considerations, and/or other such constraints). Further, in some implementations the control circuit 102 and/or another system tracks customers' purchases and over time identifies constraints relative to the customer's purchase patterns (e.g., product preferences, manufacturer preferences, quantities purchased, rates of purchase, qualities purchased, organic or not, and/or other such factors). In some instances, the customer may further specify some of this information as part of the constraints and/or within a customer profile. Accordingly, the control circuit 102 in applying the set of one or more constraint rules specific to the customer may access the customer database and limit which products and/or types of products that are identified to satisfy the ingredients of the recipe. For example, referring back to FIG. 2, the control circuit may limit the type of flour selected to a lower cost per unit weight of flour and at a maximum size available based on the customer's historic purchases. As a further example, the control circuit may select the RCI record 218b for fresh organic cherries based on a customer's preference for organic, fresh produce. In another example, the control circuit may limit the type of potential butter RCI records that might be selected based on dietary and/or allergy considerations.

In some embodiments, the control circuit further utilizes information obtained based on historic purchases and/or rates of use of products, which again may be maintained in the customer database by the control circuit or another customer purchase tracking system that tracks customer purchases over time. This historic purchase information may be used to determine when and whether a customer needs to purchase a product corresponding to an RCI record identified by the control circuit that the customer is expected to want to use in completing the recipe. In some embodiments, the control circuit accesses the customer database 106 corresponding to the customer submitting the recipe request and estimates from the customer database when a customer already has (e.g., at home in a cupboard) a threshold quantity of an identified product corresponding to a specific unique product identifier of the set of corresponding unique product identifiers of the set of RCI records identified to be used in implementing the recipe. For example, the recipe may call for three cups of flour, and based on a customer purchase history, and in some instances an estimated rate of use of the product, the control circuit may predict that the customer has at least three cups remaining from a bag of flour purchased in the past. As such, when it is estimated that the customer has the threshold quantity of the identified product, the control circuit in applying the constraint rules can exclude that unique product identifier from being purchased and from the virtual shopping cart.

Further, in some applications, the control circuit may notify the customer of the estimated quantity the customer is believed to already have, and request the customer confirm that the product should or should not be purchased. The threshold may be set based on a quantity of a product the recipe calls for, a quantity called for plus a margin of error (which may vary based on a customer's predicted rate of use and/or on the quantity called for), customer-specified preferences, and/or other such factors. In some instances, the control circuit in estimating quantities of a product that a customer has corresponding to an RCI record identified, the control circuit may also consider alternative RCI records in determining whether the customer has sufficient quantities of a product and/or in setting one or more thresholds. For example, the control circuit may identify a particular RCI record for a particular quantity of organic flour, and identify that the customer has less than the threshold quantity of that organic flour to complete the recipe but already has additional other flour that can be substituted into the recipe in addition to what the customer has of the organic flour and/or in place of the organic flour. Accordingly, the control circuit may exclude the organic flour from the virtual shopping cart and/or may notify the customer of the decision to exclude the organic flour. The control circuit may further request confirmation of one or more of the exclusions. By further taking advantage of customer considerations and/or constraints the control circuit, in some embodiments, further customizes the resulting, the selected products to be identified relative to a particular recipe, and/or the products to be purchased to allow the customer to implement the recipe.

Some embodiments improve the rate at which the system 100 operates by tracking which recipes are being requested, frequencies at which products are requested, ratings of recipes (e.g., received by customers through an APP on their computing device), and the like. Using this information, some embodiments preform at least some memorization of commonly accessed and/or requested genericized recipe G-RC records and corresponding RC records and RCI records. The control circuit 102, in some implementations, identifies a set of genericized RC records, of the plurality of RC records, that have been searched by a threshold number of customers over a threshold period of time. In some instances, such a search rate may correspond to a set of most searched genericized RC records, genericized RC records searched at a threshold rate, genericized RC records having a threshold increased rate of being searched, and/or other such threshold considerations. Based on this threshold identification, the control circuit can cause at least some of the information associated with the genericized RC record and/or subordinate RC records and RCI records. In some embodiments, the control circuit causes the caching, for each of a set of genericized RC records, at least the links 204 to the RC records and RCI records directly linked from the corresponding genericized RC records. Further, the caching may include caching in multiple different servers 116 and/or memory to improve accesses and/or provide redundant access. Still further, some embodiments cause the caching to occur and multiple geographically distributed servers and/or memory systems to reduce network traffic and distribute the processing and improve bandwidth of the system 100.

In addition to caching, some embodiments further track the access to the cached information in determining whether to maintain the cached information or make the memory space available for one or more other generic RC records and corresponding recipes that are, for example, being more regularly requested. In some implementations, the control circuit is configured to identify when a different genericized RC record of a set of genericized RC records is searched less than a second threshold number of times during a second threshold period of time, and to purge the cache of the links to the RC records and RCI records directly linked to the different genericized RC record.

Some embodiments further take advantage of the requested recipes and the corresponding unique specific products to enable the customer to complete the recipe to determine inventory demands and/or predict inventory needs at a particular retail store based on recipes searched. The control circuit, in some applications, tracks the rate at which a set of different recipes is accessed by customers. Based on the number of searches for each recipe, the rate of searching, and/or the change in rate of searches, the control circuit can predict inventory demands on unique product identifiers linked to the genericized RC records associated with each of the set of recipes as a function of the number of searches, rates at which the different recipes are accessed, and/or changes in rates of searches. For example, the control circuit may detect a rate of search of recipes corresponding to the Christmas holiday. Through the linking defined within the recipe data structure, the control circuit can identify the products commonly selected and/or selected a threshold number of times or at a threshold rate, and project that sales of those products are going to increase, decrease, or stay consistent. The rate of requests may be an increased rate of requests, a decrease in a rate of requests, or a consistent rate of request. Further, in some instances, the control circuit considers historic sales (e.g., sales in one or more previous years and changes in sales rates in previous years during a corresponding period of the year), as part of the predicted sales. Using this information, the control circuit may predict an inventory demand as a function of the change or non-changing rate of requested assess to one or more recipes. As recipes become more popular, the demands for at least some products to implement these recipes is going to increase. Similarly, as recipes become less popular, demands for some products linked to these recipes is expected to decrease. Further, changes in sales of one or more of these products can further be considered in relation to the change in popularity of access to one or more recipes in determining an expected change in inventory demand for one or more products. In some embodiments, for example, the control circuit may detect a percentage change in rate of access to a particular recipe, and predict a corresponding percentage change in at least some of the products that can be used in satisfying the ingredients of that recipe. Further, in some instances, the percentage change may be distributed over multiple different products that can satisfy a particular ingredient, which may be distributed equally across the multiple different products, may be distributed based on typically historic sales of these multiple products over a relatively long period of time (e.g., 3 months, a year, 5 years), may be distributed based on typically historic sales of these multiple products over similar time of year for one or more previous years (e.g., 2 months prior to Christmas, three weeks before Thanksgiving, etc.), other such distributions of the percentage change, or a combination of two or more of such distributions. As such, the system 100 utilizes recipe access and/or purchase information based on recipe access as at least part of the information in predicting inventory demand and/or change in inventory demand, whether increase, decrease or consistent.

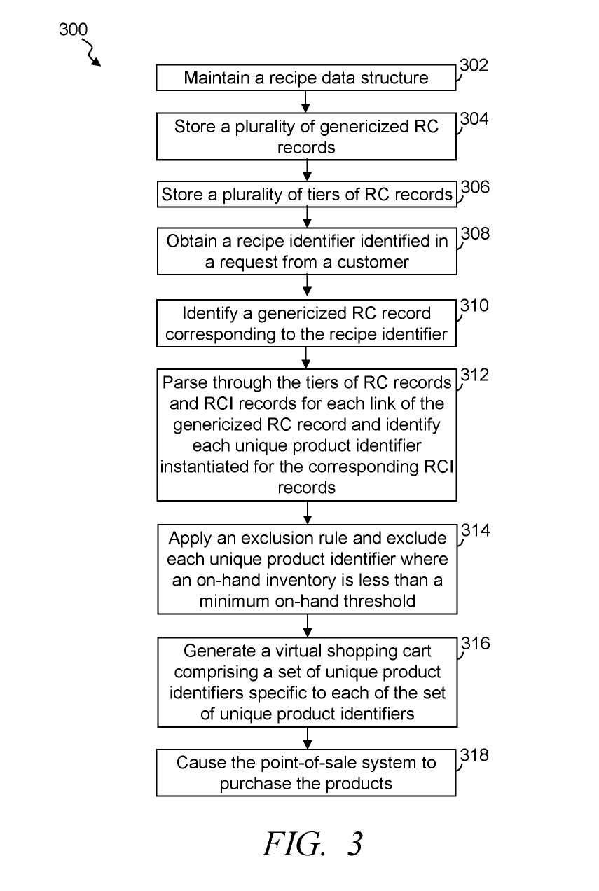

FIG. 3 illustrates a simplified flow diagram of an exemplary process 300 of storing and retrieving data in a computer memory providing retail-specific instantiations of items of recipes, in accordance with some embodiments. In step 302, a recipe data structure is maintained within a recipe database 104. In step 304, a plurality of genericized RC records are stored within the recipe data structure. Each of the genericized RC records corresponds to a single recipe and comprises a genericized RC record identifier, and at least one cell comprising a link to at least one of one or more subordinate RC records and/or at least one RCI record of a plurality of RCI records. In step 306, a plurality of tiers of RC records are stored. Typically, each RC record is dependent upon and associated with at least one of the plurality of genericized RC records and at least some of the RC records are dependent upon and associated with one or more predecessor RC records from one or more higher tiers. Further, each of the RC records typically comprises an RC record identifier and at least one cell comprising a link to one or more of: at least one further subordinate RC record and at least one of the plurality of RCI records. In some instances, some or all of the RC records may include links to one or more predecessor RC records and/or one or more predecessor genericized RC records. The plurality of RCI records typically each comprise an RCI identifier and a particular unique product identifier corresponding to a particular product to be purchased from a particular retailer. The unique product identifier may be unique to the retailer or may extend to multiple retailers for the same product. In step 308, a recipe identifier is obtained that is identified in a request from a customer. As described above, a customer may submit a request, for example, through a graphical user interface allowing the customer to search and/or scroll through recipes.

In step 310, a genericized RC record is identified corresponding to the recipe identifier by the customer. In step 312, the control circuit parses through the tiers of RC records and corresponding RCI records for each link branching from the identified genericized RC record to each RC record and each RCI record to identify each unique product identifier instantiated for the corresponding RCI records that can be used in implementing the identified recipe. In step 314, one or more exclusion rules are applied, and in some instances, excludes each unique product identifier where an on-hand inventory count for the unique product identifier at the retailer is less than a minimum on-hand threshold.

In step 316, a virtual shopping cart is generated that comprises a set of unique product identifiers configured to be applied by a point-of-sale system 112 in purchasing for the customer products specific to each of the set of unique product identifiers. In step 318, the control circuit 102 causes the point-of-sale system to purchase the products corresponding to the set of unique product identifiers.

Some embodiments further apply a set of constraint rules specific to the customer requesting the recipe and identify specific to the customer a set of RCI records and a corresponding unique product identifier of each RCI record of the set of RCI records to enable the customer to complete the recipe in accordance with constraints corresponding to the customer. The set of the identified corresponding unique product identifiers is compiled based on the applied constraints. Accordingly, in some applications, some of the potential RCI records and/or RC records are excluded in identifying relevant unique product identifiers. The resulting set of unique product identifiers is thus often limited based on the constraint rules to be consistent with the needs, preferences and/or historic purchase pattern of the customer. For example, some embodiments access a customer database corresponding to the requesting customer. From the customer database the control circuit can estimate when the requesting customer already has a threshold quantity of a first product corresponding to a first unique product identifier of the set of corresponding unique product identifiers of the set of RCI records. This estimation can be based on past historic purchases, estimated usage and/or consumption rates, and/or other such information. Further, this estimation can take into consideration other recipes previously and/or concurrently accessed and/or requested that also call for the first product. As such, the control circuit can take into consideration one or more other recipes the customer may implement and the ingredients that those one or more recipes call for to implement. When the customer already has the threshold quantity of the first product, the control circuit can exclude that unique product identifier corresponding to that first product from being purchased.

In some implementations, the system 100 enhances operational speed, efficiency and access through, in part, the memorization of genericized RC records that are requested frequently, have a change in request rate, and/or otherwise are identified as expected to be frequently requested. For example, a set of genericized RC records, of the plurality of RC records, can be identified that have been searched by a threshold number of customers over a threshold period of time as corresponding to a set of most searched genericized RC records, corresponding to a set of recipes having a threshold increased rate of requests, having a threshold popularity rating, and/or other such criteria that indicates the one or more recipes of the set are expected to be regularly searched and/or requested. The control circuit caches, for each of the genericized RC records of the set of one or more genericized RC records, the links to at least some of the RC records and RCI records directly linked from the corresponding genericized RC records. This caching makes the information more readily available and allows for the information to more quickly be distributed to customers. In some embodiments, the control circuit identifies when a genericized RC record of the set of genericized RC records is searched less than a threshold number of times during a period of time, and purges the cache of the links to the RC records and RCI records directly linked to the second genericized RC record.

As described above, the control circuit further maintains the recipe data structure and adds additional recipes while genericizing those recipes to be subsequently utilized in providing a customer customization of products to be used in completing the recipe. In some embodiments, the control circuit receives a recipe from a customer. The recipe typically includes a listing of multiple different ingredients and quantities of each of those different ingredients. The control circuit further defines a new genericized RC record within the recipe data structure corresponding to and specific to the newly received recipe and causes a corresponding genericized RC record identifier to be generated and associated with the new genericized RC record. Additionally, the control circuit genericizes one or more and typically each of the different ingredients to identify a generic class for each of the different ingredients. For example, a recipe may call for flour and the data structure typically includes a generic class of “Flour” corresponding to at least RC record, which may be linked to one or more RCI records and/or multiple subordinate RC records (e.g., whole wheat flour, bleached all-purpose flour, cake flour, etc.) which may in turn be linked to one or more RCI records or subordinate RC records. Further, some embodiments identify, for each of the different ingredients of a newly received recipe, at least one RC record for each generic class, and cause links to be established between the newly genericized RC record and each of the identified RC records corresponding to the different ingredients. In causing the links to be established, some embodiments parse through the tiers of RC records and confirming links between each of the RC records and at least one of a subordinate RC record and RCI records comprising a corresponding unique product identifier of a particular product to satisfy one of the ingredients of the second recipe.

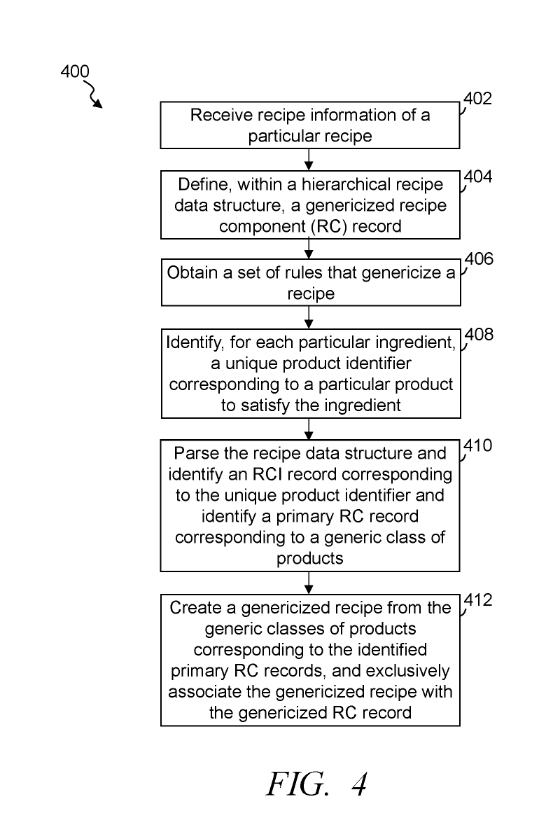

FIG. 4 illustrates a simplified flow diagram of an exemplary process 400 of maintaining and providing access to customer-supplied recipes, in accordance with some embodiments. In step 402, recipe information of a particular recipe is received from a remote customer. For example, a customer may submit a recipe from their computing device 122 over the computer network 110 (e.g., the Internet) to a website hosted by one or more of the servers 116. The recipe information includes at least identifiers of each ingredient to be utilized in completing the recipe and a corresponding quantity of each ingredient. In step 404, genericized RC record exclusively associated with the received recipe is defined within the hierarchical recipe data structure maintained within a recipe database 104.

In step 406, a set of rules is obtained that genericize a recipe as a function of linkings defined within the recipe data structure. As described above, these rules are inconsistent with previous recipe systems in that the rules work through tiers of RC records to classes of RC records, often defined by a primary RC record. In step 408, one or more of the set of rules are applied to identify, for each particular ingredient, a unique product identifier corresponding to a particular product to satisfy the ingredient and quantity of ingredient. For example, a customer may identify a particular product that customer recommends or wishes to purchase to be used in implementing the recipe, may identify a particular product (e.g., through a selection of one of multiple graphically displayed representations and/or listings of potential products, identified based on a class of products and using linking within the recipe data structure to identify a particular product, etc.).

In step 410, the recipe data structure is parsed, for each identified unique product identifier based on the unique product identifier to identify, within the recipe data structure, an RCI record corresponding to the identified unique product identifier and identify based on linking within the recipe data structure a primary RC record corresponding to a generic class of products comprising the particular product corresponding to the identified unique product identifier. In step 412, a genericized recipe is created from the generic classes of products corresponding to the identified primary RC records, and exclusively associating the genericized recipe with the genericized RC record. For example, for a cherry pie recipe, ingredients of one 16 oz. can of sweet cherries, X cups of brown sugar, Y cups of granulated sugar, W cups of corn starch, 1 Great Value frozen pie crust, 8 oz. of butter, and ½ table spoon of McCormick almond extract, may be specified in respective quantities, with further directions regarding how and when to combine the different quantities of different ingredients, and how to cook the pie. Specific products for the ingredients can be obtained and/or a class of product may be identified, and through the recipe data structure, the control circuit may identify primary RC records of cherries, sugar, corn starch, pie crust, butter and almond extract. The genericized RC record can be created based on these primary RC records that are further linked through multiple tiers of RC records to at least one and typically multiple different RCI records each corresponding to specific products that can be purchased from the retailer. The directions can further be saved in the recipe data structure within the genericized RC record and/or linked to the genericized RC record.

Some embodiments, in response to receiving the request to add a new recipe to the recipe database, parse the recipe data structure and determine whether one or more existing genericized RC records, each corresponding to a separate different genericized recipe, are linked to each of the primary RC records of a set of primary RC records corresponding to the identified unique product identifiers. The control circuit directs the creation of the genericized recipe of the newly received recipe when one or more of the existing genericized RC records do not link to the primary RC records of the set of primary RC records. Some embodiments parse the recipe data structure to identify, for each of the identified unique product identifiers, the generic ingredient information by: accessing the data structure, accessing a first RCI record for the particular unique product identifier, identifying a first predecessor RC record linked to the particular first RCI record; and following a linking path from the first predecessor RC record to a preceding second predecessor RC record linked to the first predecessor RC record and within a link path to the primary RC record. Typically, the second predecessor RC record comprises at least one cell comprising a link to multiple subordinate RC records including the first subordinate RC record that comprises a link to the first RCI record.

In some embodiments, when identifying for each particular ingredient the unique product identifier corresponding to the particular product, the control circuit receives a selection by the customer of the particular product. The unique product identifier can be identified corresponding to the selected particular product, and the corresponding RCI record can be identified associated with the identified unique product identifier. This RCI record can then be linked with the newly created recipe and corresponding genericized RC record. The control circuit, in some applications, provides additional customers subsequent access to use the genericized recipes by generating a different customized recipe for the different customers of the additional customers based on at least one different linking within the recipe data structure to a different RCI record corresponding to a different unique product identifier exclusively associated with a different particular product that replaces one of the particular products selected by the customer that requested the recipe be added to the customer database. As introduced above, the system 100 can customize the particular products and/or ingredients used to implement a genericized recipe specific to a customer considering the recipe.

In generating the recipe for the subsequent customer requesting the recipe, the control circuit can apply an exclusion rule and exclude those unique product identifiers, corresponding to potential RCI records that are linked to the genericized RC record, where an on-hand inventory count for the unique product identifier at the retailer is less than a minimum on-hand threshold. A virtual shopping cart can be automatically created by the control circuit comprising a set of unique product identifiers configured to be applied by the point-of-sale system in purchasing for the customer products specific to each of the set of unique product identifiers. Further, the control circuit can cause a point-of-sale system 112 to purchase the products corresponding to the set of unique product identifiers. Some embodiments, in generating the customized product listing and/or customized recipe apply a set of constraint rules specific to the requesting customer and identify specific to the requesting customer a set of RCI records and a corresponding unique product identifier of each RCI record of the set of RCI records to enable the requesting customer to complete the requested recipe in accordance with constraints corresponding to the requesting customer. Based on these RCI records, a set of the identified corresponding unique product identifiers can be compiled.

The customization of listings of products and/or the requested recipe can include accessing customer data within the customer database 106 corresponding to the requesting customer, and estimating from the customer database when a customer has a threshold quantity of one or more products corresponding to one or more of the unique product identifiers of the set of corresponding unique product identifiers of the set of RCI records. When the customer already has a threshold quantity of a product identified, the control circuit can exclude the corresponding unique product identifier from being purchased. In some embodiments, the control circuit can consider more than one recipe and/or other information in determining whether the customer has a threshold quantity of the particular product. For example, the customer may have previously selected one or more other recipes that may also include the particular product, and as such, the threshold may be considered based on at least the total amount of that particular product that the customer will need to complete the multiple recipes. Additionally or alternatively, the system may consider a rate of use by that customer for that product, an indication by the customer for a quantity of that product prior to selecting a current recipe (e.g., previously added to a shopping list in a customer profile of the customer database), and/or other such factors in setting the threshold quantity and/or in identifying a particular product (e.g., a quantity of a particular type of product) in selecting the RCI record. Some embodiments track rates at which a set of different recipes are accessed by customers, and predict inventory demands on products corresponding to particular unique product identifiers linked to the genericized RC records associated with each of the set of recipes as a function of the rates at which the different recipes are accessed and/or changes in rates (e.g., detecting change in the number of accesses per hour, per day, per week, etc.; detecting changes in the types of customer access; and/or other such changes). For example, as the number of accesses to a particular recipe increases, the expected sales of products to implement that particular recipe is expected to increase, unless other factors dictate differently (e.g., a corresponding reduction in the accessing of a different second recipe that also calls for a similar product could offset the expected increase due to the expected corresponding reduction in purchases of that product corresponding to the second recipe).

The recipe data structure is maintained in one or more databases and establishes hierarchical categorization and instantiation allocation of product information and specific product identifiers through the linking through the tiers of RC records to the RCI records. In some implementations, many of the RC records do not include product data, while the RCI records are instantiations of some RC records comprising specific identifying information for specific products that can be purchased from a particular retailer for which the recipe data structure is maintained and typically within the retailer's inventory. For example, the RCI records comprise product identifier information (e.g., SKU, bar code number, etc.) that distinguish that particular product (e.g., 32 oz. bag of Domino Dark Brown Sugar (e.g., with identifier information #:009258592); a 5 lbs. bag of Gold Medal™ All Purpose flour (e.g., with identifier information #:9284207); a 33.5 oz. jar of Nutellas spread (e.g., with identifier information #:556139072); 32 oz. package of Great Value™ cheddar cheese (e.g., with identifier information #:009002639); etc.). In some embodiments, the RCI record further includes and/or is associated with additional data such as but not limited to one or more of brand, price, volume, unit count, calories, allergy considerations, and other such information. RC records have zero or more linked RCI records associated with that RC record. Based on the hierarchical linking the recipe data structure can be parsed through the tiers of RC records to subordinate RC records and/or RCI records of the RC record and RCI records linked to the linking path of subordinate RC records. This hierarchical association provides a linking path to the possible combinations of different ingredients that can be used to satisfy an ingredient and implement or instantiate the primary RC record using one of the set of products specified in the RCI record and contained within the inventory.

Further, this instantiation of genericized ingredients allows for the customization of specific products to satisfy an ingredient of a particular recipe requested by a customer. The customer can submit a request (e.g., through an APP on a computer, smartphone, or other such customer computing device) to a recipe search engine implemented on one or more servers 116. In some embodiments, the customer may further specify a list of one or more search constraints, and/or the control circuit may access previous customer specified constraints and/or system-defined constraints, which may be defined over time based on customer purchases, may be defined based on inventory, and/or other such constraints. For example, constraints may include a desired maximum caloric intake, monetary budget constraints, a request for a particular source of product (e.g., Great Value products, Hunts products, etc.), allergy constraints, etc. Further, the control circuit typically applied a constraint that the retailer have at least one of the potential product in inventory and/or have a threshold quantity of the product available for sale to be selected as a product to fulfill an ingredient of the requested recipe (e.g., on-hand count >0).

The one or more constraints are applied in parsing through the hierarchy of RC records and linked RCI records. Some embodiments apply weightings and/or priorities of RCI records and/or linkings between RC records and RCI records (e.g., if using a product identified by a first RCI record is inconsistent with one or more constraints, then a weighting of “0” on the RCI record and/or link to that RCI record can be applied, which in this example would exclude that linking from the hierarchical association for that ingredient or primary RC record because that product would produce an invalid result for the requesting customer). Similarly, in some embodiments, the control circuit may identify that a particular product of an RCI record satisfies the relevant constraints, and can apply a weighting to that RCI record and/or the link to that RCI record according to comparisons made between the product and the constraints. For example, if a customer specified a maximum monetary budget, and a cost for a first product corresponding to a first RCI record was less expensive than another similar second product of a sibling second RCI record linked to the same predecessor RC record, then the first RCI record can be assigned a greater weighting at least relative to that constraint than the sibling second RCI record. The control circuit can use the weighting of possible RCI records that comply with the constraints. Within the set of possible valid combinations, the control circuit can utilize the weightings to order the resulting valid RCI record combinations to select relevant products for the different ingredients of the requested recipe. The weightings, in some applications, can be based on how close to the constraints a product is and/or by how much a product exceeds those constraints. Some embodiments apply one or more association algorithms such as but not limited to Edmonds-Karp algorithm, Ford-Fulkerson method, other such methods or a combination of such methods. A resulting set of identified RCI records can then be incorporated into a virtual shopping cart and/or can be returned to the customer, which may be returned in a recipe listing along with directions to complete the instructions. Further, the system can allow the customer to review the virtual shopping cart and make relevant changes desired by the customer (e.g., taking into account information the system does not have access to, changes in desired products, etc.).

In some instances, the results are returned through a graphical user interface through which the customer can make substitutions for selected products to fulfill an ingredient within the returned recipe, remove products, add to the virtual cart, and/or other such changes. For example, in some instances, a customer may submit a separate substitution lookup request for a given product corresponding to a given RCI record. The substitution request can contain the identifier for the product and/or the RCI record identifier that is to be substituted. Using the linking within the recipe data structure, the control circuit can move back up the tiers to identify the sibling RCI records that share one or more of the same predecessor RC records with the RCI record being considered for substitution. Typically, the control circuit further applies one or more constraints to the sibling RCI records before providing the optional products for consideration by the customer (e.g., filter out the returned RCI records that would cause one or more of the constraints to be violated). The customer could use the graphical user interface to cycle through the possible substitutions for a line-item ingredient to see the effect that such a substitution would have on the attributes of the overall recipe. Further, in some applications, the control circuit can introduce suggestions, information, advertising, and the like (e.g., notify the customer that according to historic purchases it appears the customer does not need a particular product because it is believed the customer purchased that product in the past and that it has been estimated that the customer continues to have sufficient quantities of that product to complete the recipe based on intended number of servings). One or more of the potential alternative products may be highlighted or emphasized depending on one or more factors, such as how that product relates to one or more constraints. The customer can direct or drag the instantiated recipe into a virtual shopping cart and/or the control circuit may automatically add products for implementing the recipe into a virtual shopping cart. By dragging the instantiated recipe into the virtual shopping cart the customer saves significant time that the customer would otherwise spend finding the relevant products for the recipe.

The recipe data structure opens the door for many opportunities to empower customers with more flexible and efficient methods of shopping for their groceries that currently do not exist today, as the system in part can identify particular products for a particular customer to provide a customized recipe instantiation, and in some instances automatically implement purchases on behalf of the customer, which may be delivered or picked up. Further, the system enables customers and/or other users to create their own recipes by interacting with product inventory of the retailer by allowing customers to associate specific products with ingredients of the recipe. In some implementations, the identification may be similar to virtual shopping by initiating a “shopping session”, but instead of adding items to cart, the selected products identified and their RCI records are linked through the tiered menu data structure through RC records, primary RC records and the genericized RC record for the specific recipe. In some instances, upon adding each product the customer can specify a quantity and/or units for that ingredient by the recipe. When the user is done identifying particular products for particular ingredients and/or done adding the individual ingredients, the customer is left with an instance of the newly created recipe, and the genericized RC record for the recipe is created in the recipe data structure when a recipe does not already exist. The instantiations of particular products selected by the customer for the ingredients are used to identify the corresponding RCI records, and the linking up through the tiers of RC records is established between the genericized RC record for the new recipe to the corresponding RCI records of the products selected. The genericized RC record and recipe can then be shared publicly with other customers who can try it out for themselves. Some embodiments further include a review system that enables customers to review recipes they have tried. This review provides recipe quality control self-policing. Accordingly, some embodiments provide a recipe-based grocery shopping experience where the content is user-generated and self-policing.

The system 100 utilizes one or more constraints, which may be system-defined, system-learned over time, and/or customer-defined. Typically, different customers have different constraints when it comes to the foods they consume (e.g. allergies, monetary budget, brand loyalty, etc.). The system takes advantage of customer information for meal planning recipes, and identifies individual ingredients for each individual recipe, choosing between similar prospective products for each ingredient based on system and/or customer constraints. Identified products can be evaluated and/or duplicate ingredients can be compared between recipes to analyze possible consolidations to save money (e.g., two recipes both use flour; instead of buying two small containers for each recipe, the system may combine the quantities for both recipes and select a larger container to be purchased, which may provide a reduced cost and/or other benefits). The system provides an improved recipe data structure that is different from the previous data structures, is constructed differently than previous data structures, and is utilized in unique ways to improve and change the way the world shops for groceries, helping them at least save time and save money.

In some embodiments, the control circuit receives additional recipes from other customers, which typically include listings of multiple different ingredients and quantities of each of those different ingredients, and often how those ingredients are combined and other directions for completing the recipe. A genericized RC record can be created, when a corresponding genericized RC record does not already exist, within the recipe data structure corresponding to and specific to a new recipe, where a genericized RC record identifier is generated and associated with the genericized RC record. Based on the ingredients identified and/or specific products identified by a customer entering the new recipe, the control circuit genericizes each of the different ingredients to identify a generic class for each of the different ingredients. These generic classes are linked to the genericized RC record for the recipe allowing subsequent instantiation of different products for different ingredients depending upon subsequent customers' corresponding constraints. In some applications, the control circuit is configured to identify, for each of the different ingredients, at least one RC record for each generic class, and cause links to be established between the new genericized RC record and each of the identified RC records corresponding to the different ingredients. In causing the links to be established, some embodiments parse through the tiers of RC records and confirm links between each of the RC records and at least one of a subordinate RC record and RCI records comprising a corresponding unique product identifier of a particular product to satisfy one of the ingredients of the new recipe.

Further, in some embodiments, the control circuit provides additional customers access to use the genericized recipes, and generate different customized recipes for different customers based on at least one different linking within the recipe data structure to a different RCI record corresponding to a different unique product identifier exclusively associated with a different particular product that replaces one of the particular products selected by a customer that previously added the selected recipe, and/or different than another customer that subsequently selects the same recipe. As introduced above, in some embodiments, the system 100 may include one or more point-of-sale systems that are communicatively coupled with the control circuit. The control circuit in generating the recipe applies one or more exclusion rules and can exclude unique product identifiers, corresponding to RCI records linked to the genericized RC record for a particular recipe selected by a customer. For example, the control circuit may exclude an RCI record and corresponding product when an on-hand inventory count at the retailer for the unique product identifier of that product is less than a minimum on-hand threshold. A virtual shopping cart can be generated by the control circuit comprising a set of unique product identifiers configured to be applied by the point-of-sale system in purchasing for a customer products specific to each of the set of unique product identifiers. The control circuit can further cause the point-of-sale system to purchase the products corresponding to the set of unique product identifiers. Different sets of constraint rules can be applied for different customers to identify, specific to those different customers, different sets of RCI records (and a corresponding unique product identifier of each RCI record of the set of RCI records) to enable the different customers to complete the recipe in accordance with constraints corresponding to each different customer, and compile the sets of the identified corresponding unique product identifiers.

In some embodiments, the control circuit accesses a customer database 106 corresponding to each customer requesting recipe data, and estimates from the customer database when a customer has a threshold quantity of a product corresponding to a unique product identifier of a set of corresponding unique product identifiers of a set of RCI records that are to be used in completing a recipe. The control circuit can exclude one or more unique product identifiers from being purchased when it is estimated that the customer already has a sufficient quantity of the product. Further, in some embodiments, the control circuit tracks rates at which a set of different recipes is accessed by customers, and predicts inventory demands on unique product identifiers linked to the genericized RC records associated with each of the set of recipes as a function of the rates at which the different recipes are accessed by customers.

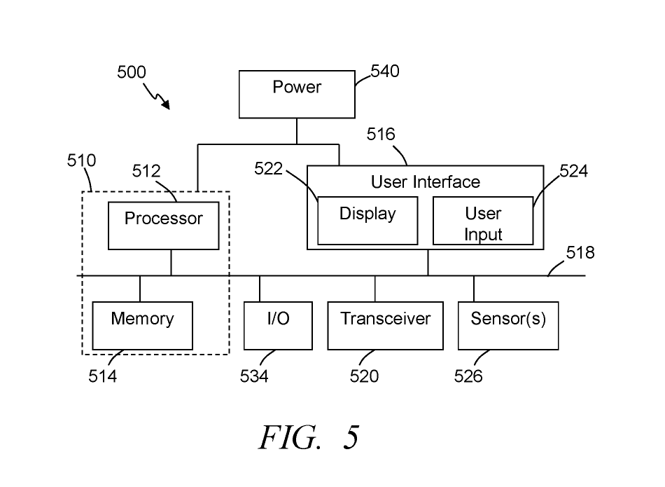

Further, the circuits, circuitry, systems, devices, processes, methods, techniques, functionality, services, servers, sources and the like described herein may be utilized, implemented and/or run on many different types of devices and/or systems. FIG. 5 illustrates an exemplary system 500 that may be used for implementing any of the components, circuits, circuitry, systems, functionality, apparatuses, processes, or devices of the system 100 of FIG. 1, and/or other above or below mentioned systems or devices, or parts of such circuits, circuitry, functionality, systems, apparatuses, processes, or devices. For example, the system 500 may be used to implement some or all of the control circuit 102, the server 116, the point of sale system 112, the product distribution system 124, the inventory system, and/or other such components, circuitry, functionality and/or devices. However, the use of the system 500 or any portion thereof is certainly not required.

By way of example, the system 500 may comprise a control circuit or processor module 512, memory 514, and one or more communication links 518, paths, buses or the like. Some embodiments may include one or more user interfaces 516, and/or one or more internal and/or external power sources or supplies 540. The control circuit 512 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 512 can be part of control circuitry and/or a control system 510, which may be implemented through one or more processors with access to one or more memory 514 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 500 may be used to implement one or more of the above or below, or parts of, components, circuits, systems, processes and the like.

The user interface 516 can allow a user to interact with the system 500 and receive information through the system. In some instances, the user interface 516 includes a display 522 and/or one or more user inputs 524, such as buttons, touch screen, track ball, keyboard, mouse, etc., which can be part of or wired or wirelessly coupled with the system 500. Typically, the system 500 further includes one or more communication interfaces, ports, transceivers 520 and the like allowing the system 500 to communicate over a communication bus, a distributed computer and/or communication network 110 (e.g., a local area network (LAN), the Internet, wide area network (WAN), etc.), communication link 518, other networks or communication channels with other devices and/or other such communications or combination of two or more of such communication methods. Further the transceiver 520 can be configured for wired, wireless, optical, fiber optical cable, satellite, or other such communication configurations or combinations of two or more of such communications. Some embodiments include one or more input/output (I/O) ports 534 that allow one or more devices to couple with the system 500. The I/O ports can be substantially any relevant port or combinations of ports, such as but not limited to USB, Ethernet, or other such ports. The I/O interface 534 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 526 to provide information to the system and/or sensor information that is communicated to another component, such as the control circuit 102. The sensors can include substantially any relevant sensor, such as distance measurement sensors (e.g., optical units, sound/ultrasound units, etc.), optical-based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 500 comprises an example of a control and/or processor-based system with the control circuit 512. Again, the control circuit 512 can be implemented through one or more processors, controllers, central processing units, logic, software and the like. Further, in some implementations the control circuit 512 may provide multiprocessor functionality.

The memory 514, which can be accessed by the control circuit 512, typically includes one or more processor-readable and/or computer-readable media accessed by at least the control circuit 512, and can include volatile and/or nonvolatile media, such as RAM, ROM, EEPROM, flash memory and/or other memory technology. Further, the memory 514 is shown as internal to the control system 510; however, the memory 514 can be internal, external or a combination of internal and external memory. Similarly, some or all of the memory 514 can be internal, external or a combination of internal and external memory of the control circuit 512. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 110. The memory 514 can store code, software, executables, scripts, data, content, lists, programming, programs, log or history data, user information, customer information, product information, and the like. While FIG. 5 illustrates the various components being coupled together via a bus, it is understood that the various components may actually be coupled to the control circuit and/or one or more other components directly.

In some embodiments, systems and methods store and retrieve data in a computer memory providing retail-specific instantiations of products of recipes, comprising: a control circuit; a recipe database coupled with the control circuit and storing a hierarchical recipe data structure; an inventory database specific to a particular retailer having thousands of products available for purchase by customers, wherein the inventory database maintains on-hand inventory data of the thousands of products; and a point-of-sale system communicatively coupled with the control circuit; wherein the control circuit is configured, for the particular retailer, to maintain the recipe data structure to comprise: a plurality of genericized recipe component (RC) records, wherein each of the genericized RC records corresponds to a single recipe and comprises a genericized RC record identifier, and at least one cell comprising a link to at least one of: at least one subordinate RC record and at least one recipe component instantiation (RCI) record of a plurality of RCI records; a plurality of tiers of RC records, wherein each RC record is dependent upon and associated with at least one of the plurality of genericized RC records and at least some of the RC records are dependent upon and associated with one or more predecessor RC records from one or more higher tiers, wherein each of the RC records comprises an RC record identifier and at least one cell comprising a link to one or more of: at least one further subordinate RC record and at least one of the plurality of RCI records; and the plurality of RCI records each comprising an RCI identifier and a particular unique product identifier corresponding to a particular product to be purchased from the particular retailer; and the control circuit is configured to: obtain a first recipe identifier identified in a request from a first customer; identify a first genericized RC record corresponding to the first recipe identifier; parse through the tiers of RC records and corresponding RCI records for each link of the first genericized RC record to each RC record and each RCI record and identifying each unique product identifier instantiated for the corresponding RCI records that can be used in implementing the identified first recipe; apply a first exclusion rule and excluding each unique product identifier where an on-hand inventory count for the unique product identifier at the retailer is less than a minimum on-hand threshold; generate a virtual shopping cart comprising a set of unique product identifiers configured to be applied by the point-of-sale system in purchasing for the first customer products specific to each of the set of unique product identifiers; and cause the point-of-sale system to purchase the products corresponding to the set of unique product identifiers.

Further, some embodiments provide methods of storing and retrieving data in a computer memory providing retail-specific instantiations of products of recipes, comprising: by a control circuit: maintaining, within a recipe database, a recipe data structure comprising: storing a plurality of genericized recipe component (RC) records, wherein each of the genericized RC records corresponds to a single recipe and comprising a genericized RC record identifier, and at least one cell comprising a link to at least one of: at least one subordinate RC record and at least one recipe component instantiation (RCI) record of a plurality of RCI records; storing a plurality of tiers of RC records, wherein each RC record is dependent upon and associated with at least one of the plurality of genericized RC records and at least some of the RC records are dependent upon and associated with one or more predecessor RC records from one or more higher tiers, wherein each of the RC records comprises an RC record identifier and at least one cell comprising a link to one or more of: at least one further subordinate RC record and at least one of the plurality of RCI records, wherein the plurality of RCI records each comprising an RCI identifier and a particular unique product identifier corresponding to a particular product to be purchased from the particular retailer; and obtaining a first recipe identifier identified in a request from a first customer; identifying a first genericized RC record corresponding to the first recipe identifier; parsing through the tiers of RC records and corresponding RCI records for each link of the first genericized RC record to each RC record and each RCI record and identifying each unique product identifier instantiated for the corresponding RCI records that can be used in implementing the identified first recipe; applying a first exclusion rule and excluding each unique product identifier where an on-hand inventory count for the unique product identifier at the retailer is less than a minimum on-hand threshold; generating a virtual shopping cart comprising a set of unique product identifiers configured to be applied by a point-of-sale system in purchasing for the first customer products specific to each of the set of unique product identifiers; and causing the point-of-sale system to purchase the products corresponding to the set of unique product identifiers.

Some embodiments provide retailer systems to incorporate customer-supplied recipes. These systems include a control circuit; a recipe database communicatively coupled with the control circuit and storing a hierarchical recipe data structure; a network interface communicatively coupling the control circuit with at least one external distributed communication network enabling acceptance of recipe information from multiple different customers; wherein the control circuit, in maintaining the recipe data structure is configured to: receive, from a remote first customer, recipe information of a first particular recipe, wherein the recipe information comprises identifiers of each ingredient to be utilized in completing the recipe and a corresponding quantity of each ingredient; define, within the recipe data structure, a first genericized recipe component (RC) record exclusively associated with the first recipe; identify, for each particular ingredient, a unique product identifier corresponding to a particular product to satisfy the ingredient and quantity of the ingredient; obtain a first set of rules that genericize a recipe as a function of linking defined within the recipe data structure; apply the first set of rules to: parse, for each identified unique product identifier, the recipe data structure based on the unique product identifier and identify, based on linking defined within the recipe data structure corresponding to a recipe component instantiation (RCI) record corresponding to the identified unique product identifier, a primary RC record corresponding to a generic class of products comprising the particular product corresponding to the identified unique product identifier; and create a genericized first recipe from the generic classes of products corresponding to the identified primary RC records, and exclusively associating the genericized first recipe with the first genericized RC record.

Some embodiments provide methods of maintaining and providing access to customer-supplied recipes, comprising: by a control circuit: receiving, from a remote first customer, recipe information of a first particular recipe, wherein the recipe information comprises identifiers of each ingredient to be utilized in completing the recipe and a corresponding quantity of each ingredient; defining, within a hierarchical recipe data structure maintained within a recipe database, a first genericized recipe component (RC) record exclusively associated with the first recipe; obtaining a first set of rules that genericize a recipe as a function of linking defined within the recipe data structure; applying the first set of rules and identifying, for each particular ingredient, a unique product identifier corresponding to a particular product to satisfy the ingredient and quantity of ingredient; parsing, for each identified unique product identifier, the recipe data structure based on the unique product identifier and identify, within the recipe data structure, a recipe component instantiation (RCI) record corresponding to the identified unique product identifier and identify based on linking within the recipe data structure a primary RC record corresponding to a generic class of products comprising the particular product corresponding to the identified unique product identifier; and creating a genericized first recipe from the generic classes of products corresponding to the identified primary RC records, and exclusively associating the genericized first recipe with the first genericized RC record.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A retailer system to incorporate customer-supplied recipes, comprising:
a control circuit;
a recipe database communicatively coupled with the control circuit and storing a hierarchical recipe data structure;
a network interface communicatively coupling the control circuit with at least one external distributed communication network enabling acceptance of recipe information from multiple different customers;
wherein the control circuit, in maintaining the recipe data structure is configured to:
receive, from a remote first customer, recipe information of a first particular recipe, wherein the recipe information comprises identifiers of each ingredient to be utilized in completing the recipe and a corresponding quantity of each ingredient;
define, within the recipe data structure, a first genericized recipe component (RC) record exclusively associated with the first recipe;
identify, for each particular ingredient, a unique product identifier corresponding to a particular product to satisfy the ingredient and quantity of the ingredient;
obtain a first set of rules that genericize a recipe as a function of linking defined within the recipe data structure;
apply the first set of rules to:
parse, for each identified unique product identifier, the recipe data structure based on the unique product identifier and identify, based on linking defined within the recipe data structure corresponding to a recipe component instantiation (RCI) record corresponding to the identified unique product identifier, a primary RC record corresponding to a generic class of products comprising the particular product corresponding to the identified unique product identifier; and
create a genericized first recipe from the generic classes of products corresponding to the identified primary RC records, and exclusively associating the genericized first recipe with the first genericized RC record.

2. The system of claim 1, wherein the control circuit is configured to:
parse the recipe data structure and determine whether one or more existing genericized RC records, each corresponding to a separate different genericized recipe, are linked to each of the primary RC records of a combination set of primary RC records corresponding to the identified unique product identifiers; and
direct the creation of the genericized first recipe when one or more of the existing genericized RC records do not link to the primary RC records of the combination set of primary RC records.

3. The system of claim 1, wherein the control circuit in parsing the recipe data structure and identifying, for each of the identified unique product identifiers, the generic ingredient information comprises accessing the data structure, accessing an RCI record for the particular unique product identifier, identifying a first predecessor RC record linked to the particular RCI record, and following a linking path from the predecessor RC record to a preceding second predecessor RC record linked to the first predecessor RC record and within a link path to the primary RC record.

4. The system of claim 3, wherein the second predecessor RC record comprises at least one cell comprising a link to multiple subordinate RC records including the first subordinate RC record comprising the first RCI record.

5. The system of claim 3, wherein the control circuit in identifying for each particular ingredient the unique product identifier corresponding to the particular product to satisfy the ingredient receives a selection by the first customer of the particular product and identifying the unique product identifier corresponding to the selected particular product, identify the corresponding RCI record associated with the identified unique product identifier, and link the RCI record with the first recipe.

6. The system of claim 1, wherein the control circuit is further configured to:
provide additional customers access to use the genericized first recipes; and
generate a different customized second recipe for a second customer of the additional customers based on at least one different linking within the recipe data structure to a different RCI record corresponding to a different unique product identifier exclusively associated with a different particular product that replaces one of the particular products selected by the first customer.

7. The system of claim 6, further comprising:
a point-of-sale system communicatively coupled with the control circuit;
wherein the control circuit in generating the second recipe applies a first exclusion rule and excludes unique product identifiers, corresponding to the RCI records of the customized second recipe, where an on-hand inventory count for the unique product identifier at the retailer is less than a minimum on-hand threshold;
generate a virtual shopping cart comprising a set of unique product identifiers configured to be applied by the point-of-sale system in purchasing for the second customer products specific to each of the set of unique product identifiers; and
cause the point-of-sale system to purchase the products corresponding to the set of unique product identifiers.

8. The system of claim 6, wherein the control circuit in generating the customized second recipe is configured to:
apply a set of constraint rules specific to the second customer and identify specific to the second customer a set of RCI records and a corresponding unique product identifier of each RCI record of the set of RCI records to enable the second customer to complete the second recipe in accordance with constraints corresponding to the second customer, and compile the set of the identified corresponding unique product identifiers.

9. The system of claim 8, wherein the control circuit is configured to access the customer database corresponding to the second customer, estimate from the customer database when a customer has a threshold quantity of a first product corresponding to a second unique product identifier of the set of corresponding unique product identifiers of the set of RCI records, and exclude that second unique product identifier from being purchased.

10. The system of claim 1, wherein the control circuit is configured to track rates at which a set of different recipes are accessed by customers, and predict inventory demands on unique product identifiers linked to the genericized RC records associated with each of the first set of recipes as a function of the rates at which the different recipes are accessed.

11. A method of maintaining and providing access to customer-supplied recipes, comprising:
by a control circuit:
receiving, from a remote first customer, recipe information of a first particular recipe, wherein the recipe information comprises identifiers of each ingredient to be utilized in completing the recipe and a corresponding quantity of each ingredient;
defining, within a hierarchical recipe data structure maintained within a recipe database, a first genericized recipe component (RC) record exclusively associated with the first recipe;
obtaining a first set of rules that genericize a recipe as a function of linking defined within the recipe data structure;
applying the first set of rules and identifying, for each particular ingredient, a unique product identifier corresponding to a particular product to satisfy the ingredient and quantity of ingredient;
parsing, for each identified unique product identifier, the recipe data structure based on the unique product identifier and identify, within the recipe data structure, a recipe component instantiation (RCI) record corresponding to the identified unique product identifier and identify based on linking within the recipe data structure a primary RC record corresponding to a generic class of products comprising the particular product corresponding to the identified unique product identifier; and
creating a genericized first recipe from the generic classes of products corresponding to the identified primary RC records, and exclusively associating the genericized first recipe with the first genericized RC record.

12. The method of claim 11, further comprising:
parsing the recipe data structure and determining whether one or more existing genericized RC records, each corresponding to a separate different genericized recipe, are linked to each of the primary RC records of a set of primary RC records corresponding to the identified unique product identifiers; and
directing the creation of the genericized first recipe when one or more of the existing genericized RC records do not link to the primary RC records of the set of primary RC records.

13. The method of claim 11, wherein the parsing the recipe data structure and identifying, for each of the identified unique product identifiers, the generic ingredient information comprises:
accessing the data structure, accessing an RCI record for the particular unique product identifier;
identifying a first predecessor RC record linked to the particular RCI record; and
following a linking path from the predecessor RC record to a preceding second predecessor RC record linked to the first predecessor RC record and within a link path to the primary RC record.

14. The method of claim 13, wherein the second predecessor RC record comprises at least one cell comprising a link to multiple subordinate RC records including the first subordinate RC record comprising the link to the first RCI record.

15. The method of claim 13, wherein the identifying for each particular ingredient the unique product identifier corresponding to the particular product comprises:
receiving a selection by the first customer of the particular product;
identifying the unique product identifier corresponding to the selected particular product;
identifying the corresponding RCI record associated with the identified unique product identifier; and
linking the RCI record with the first genericized RC record.

16. The method of claim 11, further comprising:
providing additional customers access to use the genericized first recipes; and
generating a different customized second recipe for a second customer of the additional customers based on at least one different linking within the recipe data structure to a different RCI record corresponding to a different unique product identifier exclusively associated with a different particular product that replaces one of the particular products selected by the first customer.

17. The method of claim 16, wherein the generating the second recipe applies a first exclusion rule and excludes those unique product identifiers, corresponding to the RCI records linked to the genericized RC records, where an on-hand inventory count for the unique product identifier at the retailer is less than a minimum on-hand threshold;
generating a virtual shopping cart comprising a set of unique product identifiers configured to be applied by the point-of-sale system in purchasing for the second customer products specific to each of the set of unique product identifiers; and
causing a point-of-sale system to purchase the products corresponding to the set of unique product identifiers.

18. The method of claim 16, wherein the generating the customized second recipe comprises:
applying a set of constraint rules specific to the second customer and identify specific to the second customer a set of RCI records and a corresponding unique product identifier of each RCI record of the set of RCI records to enable the second customer to complete the second recipe in accordance with constraints corresponding to the second customer; and
compiling the set of the identified corresponding unique product identifiers.

19. The method of claim 18, further comprising:
accessing customer data within the customer database corresponding to the second customer;
estimating from the customer database when a customer has a threshold quantity of a first product corresponding to a second unique product identifier of the set of corresponding unique product identifiers of the set of RCI records; and
excluding that second unique product identifier from being purchased.

20. The method of claim 11, further comprising:
tracking rates at which a set of different recipes are accessed by customers; and
predicting inventory demands on unique product identifiers linked to the genericized RC records associated with each of the first set of recipes as a function of the rates at which the different recipes are accessed.
